(19) United States
(12) Patent Application Publication
(10) Pub. No.: US 2005/0205697 A1
(43) Pub. Date: Sep. 22, 2005

(54) Combination showerhead with waterfall nozzle

(76) Inventor: Ying Hoi Eddie Lo, Kowloon (HK)

Correspondence Address: CONAIR CORPORATION, ONE CUMMINGS POINT ROAD, STAMFORD, CT, 06902, US

(21) Appl. No.: 11/083,402

(22) Filed: Mar. 18, 2005

Related U.S. Application Data
(60) Provisional application No. 60/554,778, filed on Mar. 20, 2004.

(51) Int. Cl. B05B 1/00

(52) U.S. Cl. 239/592; 239/443; 239/597; 239/394

(57) ABSTRACT

A shower attachment has a plurality of conventional shower outlet ports and a waterfall nozzle in fluid communication with a water inlet, and has a valve selector to selectively choose waterflow through the shower ports or though the waterfall nozzle.

### CROSS-REFERENCE TO RELATED APPLICATIONS

This application claims priority to U.S. Provisional Patent Application Ser. No. 60/554,778 filed on Mar.20, 2004, incorporated herein by reference in its entirety.

### BACKGROUND OF THE INVENTION

1. Field of the Invention

The present invention relates to showerheads and, more particularly, to a combination showerhead with multiple water outlets including a “waterfall” nozzle that produces a sheet-like water stream.

2. Description of Related Art

A variety of showerheads exist that include multiple water outlet ports. Typically, they have various streams of conventional patterns. Certain single-outlet faucet heads, most typically used for bathtubs, have relatively high width-to-height ratios at the nozzle opening to create a sheet-like or “waterfall” effect of wide, flat, generally uninterrupted stream of water.

No existing shower or faucet head is known that combines a multiple showerhead, or even a single showerhead, with a waterfall type nozzle on a single device.

### OBJECT AND SUMMARY OF THE INVENTION

It is an object of the present invention to overcome the shortcomings of the prior art mentioned above. These and other objectives are achieved by the present invention described herein. It is an object of the present invention to provide a combination faucet or shower head that includes a single or multiple nozzle shower head of a conventional type with a waterfall-type nozzle for selective flow of water. These and other objects are achieved by the present invention described herein.

The present invention is directed to a shower attachment having a plurality of conventional shower outlet ports and a waterfall nozzle in fluid communication with a water inlet, and having a valve selector to selectively choose waterflow through the shower ports or through the waterfall nozzle.

### BRIEF DESCRIPTION OF THE DRAWINGS

The present invention is more fully understood by reference to the following detailed description of an illustrative embodiment with the drawings identified below.

FIG. 1 is a bottom view of a device according to a preferred embodiment of the present invention.

FIG. 2 is a top view of the device shown in FIG. 1.

FIG. 3 is a side view of the device shown in FIG. 1.

### DETAILED DESCRIPTION OF THE INVENTION

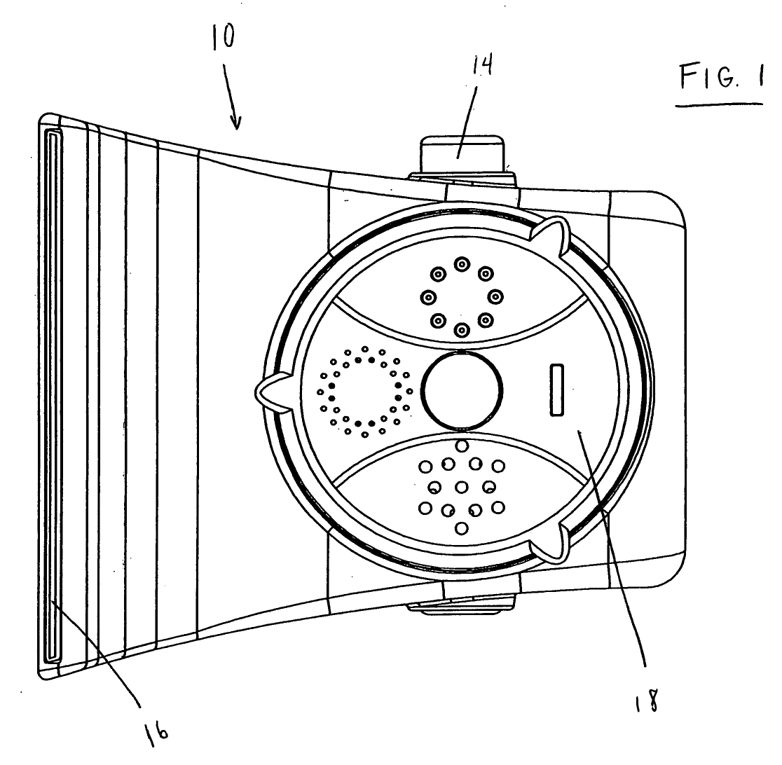

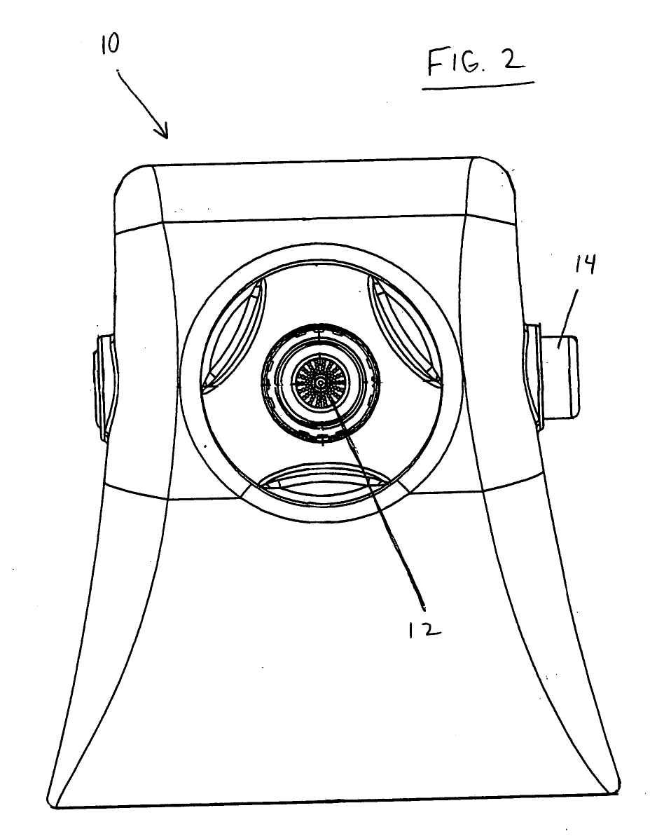

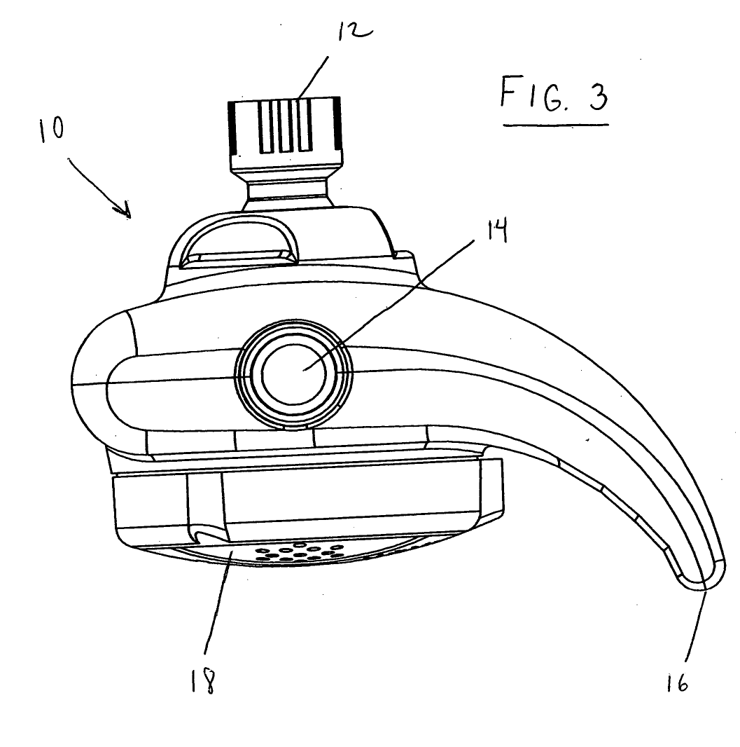

Referring to FIGS. 1-3, a shower attachment device (10) has a water inlet (12) for attachment to a typical shower faucet (not shown). A valve selector button (14) can be pushed to select either waterfall or showerhead. The valve selector button (14) is movable to selectively direct or divert water flowing from the faucet to either a waterfall nozzle (16) or conventional shower head (18). The valve selector (14) controls a conventional valve (not shown) inside the device (10).

When water is directed to the waterfall nozzle (16), which has a relatively high width-to-height ratio, a sheet or flat, continuous stream of water flows out. When water is directed to the shower head (18), typical shower spray is achieved. The shower head (18) may be a set of selectively dialed heads as shown, or a single head, each having a plurality of outlet holes as is generally known. The shower head can be rotatable, 90 degrees shift for each setting. These settings can include, for example, a mist setting, a jet massage, a full body setting and a heavy rain setting.

While a preferred embodiment of the invention has been herein disclosed and described, it is understood that various modifications can be made without departing from the scope of the invention.

1. A shower attachment device comprising:
a housing;
a water inlet for receiving water from a faucet;
a shower head; and
an outlet, wherein said outlet is a nozzle having a width greater than the height.

2. A shower attachment device according to claim 1, wherein
said outlet has a width-to-height ratio greater than 10 to 1.

3. A shower attachment device according to claim 1, wherein
said outlet has a width-to-height ratio greater than 20 to 1.

4. A shower attachment device according to claim 1, further comprising
a valve selector button adapted to control a valve to selectively direct water to either said outlet and/or said shower head.

5. A shower attachment device according to claim 1, wherein
said outlet is adapted to cause a flat, continuous stream of water to flow out.

6. A shower attachment device according to claim 1, wherein
said shower head can be a set of selectively dialed heads or a single head.
